(19) United States
(12) Patent Application Publication
(10) Pub. No.: US 2015/0170053 A1
(43) Pub. Date: Jun. 18, 2015

(54) PERSONALIZED MACHINE LEARNING MODELS

(71) Applicant: Microsoft Corporation, Redmond, WA (US)

(72) Inventor: Xu Miao, Seattle, WA (US)

(73) Assignee: Microsoft Corporation, Redmond, WA (US)

(21) Appl. No.: 14/105,650

(22) Filed: Dec. 13, 2013

(51) Int. Cl. G06N 99/00

(52) U.S. Cl. CPC G06N 99/005

(57) ABSTRACT

Machine learning may be personalized to individual users of personal computing devices, and can be used to increase machine learning prediction accuracy and speed, and/or reduce memory footprint. Personalizing machine learning can include selecting a subset of a machine learning model to load into memory. Such selecting is based, at least in part, on information collected locally by the personal computing device. Personalizing machine learning can additionally or alternatively include adjusting a classification threshold of the machine learning model based, at least in part, on the information collected locally by the personal computing device. Moreover, personalizing machine learning can additionally or alternatively include normalizing a feature output of the machine learning model accessible by an application based, at least in part, on the information collected locally by the personal computing device.

### BACKGROUND

Machine learning involves various algorithms that can automatically learn from experience. The foundation of these algorithms is built on mathematics and statistics that can be employed to predict events, classify entities, diagnose problems, and model function approximations, just to name a few examples. While there are various products available for incorporating machine learning into computerized systems, those products currently do not provide a good approach to personalizing general purpose machine learning models without compromising personal or private information of users. For example, machine learning models may be configured for general use and not for individual users. Such models may use de-identified data for training purposes, but do not take into account personal or private information of individual users. This situation can lead to relatively slow operating speeds and relatively large memory footprints.

### SUMMARY

This disclosure describes, in part, techniques and architectures for personalizing machine learning to individual users of personal computing devices without compromising privacy or personal information of the individual users. The techniques described herein can be used to increase machine learning prediction accuracy and speed, and reduce memory footprint, among other benefits. Personalizing machine learning may be performed locally at a personal computing device, and may include selecting a subset of a machine learning model to load into memory. Such selecting may be based, at least in part, on information regarding the user collected locally by the personal computing device. Personalizing machine learning may additionally or alternatively include adjusting a classification threshold value of the machine learning model based, at least in part, on the information collected locally by the personal computing device. Moreover, personalizing machine learning may additionally or alternatively include normalizing a feature output of the machine learning model accessible by an application based, at least in part, on the information collected locally by the personal computing device.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), and/or other technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which techniques described herein may be implemented.

FIG. 2 is a block diagram of a machine learning system, according to various example embodiments.

FIG. 3 is a block diagram of a machine learning model, according to various example embodiments.

FIG. 4 shows a portion of a tree of support vectors for a machine learning model, according to various example embodiments.

FIG. 5 is a flow diagram of a process for selecting a subset of a machine learning model to load into memory, according to various example embodiments.

FIG. 6 is a schematic diagram of feature measurements with respect to a classification threshold, according to various example embodiments.

FIG. 7 is a flow diagram of a process for adjusting a classification threshold of a machine learning model based, at least in part, on information collected locally by a client device, according to various example embodiments.

FIG. 8 shows feature distributions and an aggregated feature distribution, according to various example embodiments.

FIG. 9 shows normalized distributions of a feature, according to various example embodiments.

FIG. 10 shows miscalculation errors with respect to a normalized aggregated distribution of a feature, according to various example embodiments.

FIG. 11 is a flow diagram of a process for normalizing a feature output of a machine learning model based, at least in part, on information collected locally by a client device, according to various example embodiments.

### DETAILED DESCRIPTION

### Overview

In various embodiments, techniques and architectures are used to personalize machine learning to individual users of personal computing devices. For example, such personal computing devices, hereinafter called client devices, may include desktop computers, laptop computers, tablet computers, telecommunication devices, personal digital assistants (PDAs), electronic book readers, wearable computers, automotive devices, gaming devices, and so on. A client device capable of personalizing machine learning to individual users of the client device can increase accuracy and speed of machine learning prediction. Among other benefits, personalized machine learning can involve a smaller memory footprint and a smaller CPU footprint compared to the case of non-personalized machine learning. In some implementations, a user of a client device has to “opt-in” or take other affirmative action before personalized machine learning can occur.

Personalizing machine learning can be implemented in a number of ways. For example, in some implementations, personalizing machine learning can involve normalizing a feature output of a machine learning model accessible by an application executed by a client device. Normalizing the feature output can be based, at least in part, on information collected locally by the client device. Personalizing machine learning may additionally or alternatively involve adjusting a classification threshold of the machine learning model based, at least in part, on the information collected locally by the client device. Additionally or alternatively, personalizing machine learning may include selecting a subset of the machine learning model to load into memory (e.g., RAM or volatile memory) of a client device. Such selecting may also be based, at least in part, on the information collected locally by the client device.

In various embodiments involving normalizing a feature output of a machine learning model hosted by a client device, the normalizing process may be based, at least in part, on information associated with an application executed by a processor of the client device. The information, collected by the client device can include: an image, a voice or other audio sample, or a search query, among other examples. The information can include personal information of a user of the client device, such as a physical feature (e.g., mouth size, eye size, voice volume, tones, and so on) gleaned from captured images or voice samples, for example. A particular physical feature of one user is generally different from the particular physical feature of another user. A physical feature for each user is represented as a distribution of values (e.g., number of occurrences as a function of mouth size over time). Maxima and minima (e.g., peaks and valleys) of the distribution can be used to indicate a number of things, such as various states of a feature of a user. For example, a local minimum between two local maxima in a distribution of a user's mouth size can be used to define a classification boundary between the user's mouth being open or the user's mouth being closed. In general, such distributions of values for different users will be different. In particular, positions and magnitudes of peaks and valleys of the distributions are different for different users. Accordingly, and undesirably, aggregating distributions of a number of users tends to un-resolve peaks and valleys of the distributions of the individual users. In other words, combining distributions of a number of users leads to an aggregated distribution that blurs out peaks and valleys of the distributions of the individual users. Such results from combining distributions can occur for machine learning models that are based on de-identified data of multiple users. Some embodiments herein include a process of aggregating distributions of a number of users by a process of normalizing distributions of the individual users based on information collected locally. Such a process can lead to an aggregated distribution that can be resolved. Such a resolved aggregated distribution can have a clearly definable (e.g. non-ambiguous) classification boundary.

In one example implementation, a processor of the client device normalizes a feature output of the machine learning model by aligning a classification boundary (e.g., a classification threshold) of the feature output with classification boundaries of corresponding feature outputs of machine learning models hosted by other client devices.

In some implementations, machine learning model feature output can be updated, or further refined, by using de-identified data from a network. For example, normalizing the feature output of the machine learning model generates a normalized output that can be aggregated with the de-identified data received from external to the client device. De-identified data includes data that has been stripped of information (e.g., metadata) regarding an association between the data and a person to whom the data is related.

In some embodiments, methods described above may be performed in whole or in part by a server or other computing device in a network (e.g., the Internet or the cloud). The server performs normalization and aligns feature distributions of multiple client devices. The server may, for example, receive, from a first client device, a first feature distribution generated by a first machine learning model hosted by the first client device, and receive, from a second client device, a second feature distribution generated by a second machine learning model hosted by the second client device. The server may subsequently normalize the first feature distribution with respect to the second feature distribution so that classification boundaries for each of the first feature distribution and the second feature distribution align with one another. The server may then provide to the first client device a normalized first feature distribution resulting from normalizing the first feature distribution with respect to the second feature distribution. The first feature distribution may be based, at least in part, on information collected locally by the first client device. The method can further comprise normalizing the first feature distribution with respect to a training distribution so that the classification boundaries for each of the first feature distribution and the training distribution align with one another.

In various embodiments, a method performed by a system of a client device includes adjusting a classification threshold value of a machine learning model based, at least in part, on information collected locally by the client device. The information may be associated with an application executed by a processor of the client device. Such information may be considered private information of a user of the client device. A user intends to have their private information remain on the client device. For example, private information may include one or more of the following: images and/or videos captured and/or downloaded by a user of the system, images and/or videos of the user, a voice sample of the user of the system, or a search query from the user of the system. In some implementations, a user of a client device has to “opt-in” or take other affirmative action to allow the client device or system to adjust a classification threshold value of a machine learning model.

In some implementations, methods performed by a client device include a lazy-loading strategy to reduce memory and CPU footprints. For example, such methods include selecting a subset of a machine learning model to load into memory, such as random access memory (RAM) or volatile memory of the client device. Such selecting may be based, at least in part, on information collected locally by the client device. The subset of the machine learning model comprises less than the entire machine learning model.

The method also includes loading the portion of the machine learning model other than the subset of the machine learning model into the memory in response to the portion of the machine learning model being relevant to an input received during execution of the application.

In some implementations, individual real-time actions of a user of a client device need not influence personalized machine learning, while long-term behaviors of the user show patterns that can be used to personalize machine learning. For example, the feature output of the machine learning model can be responsive to a pattern of behavior of a user of the client device over at least a predetermined time, such as hours, days, months, and so on.

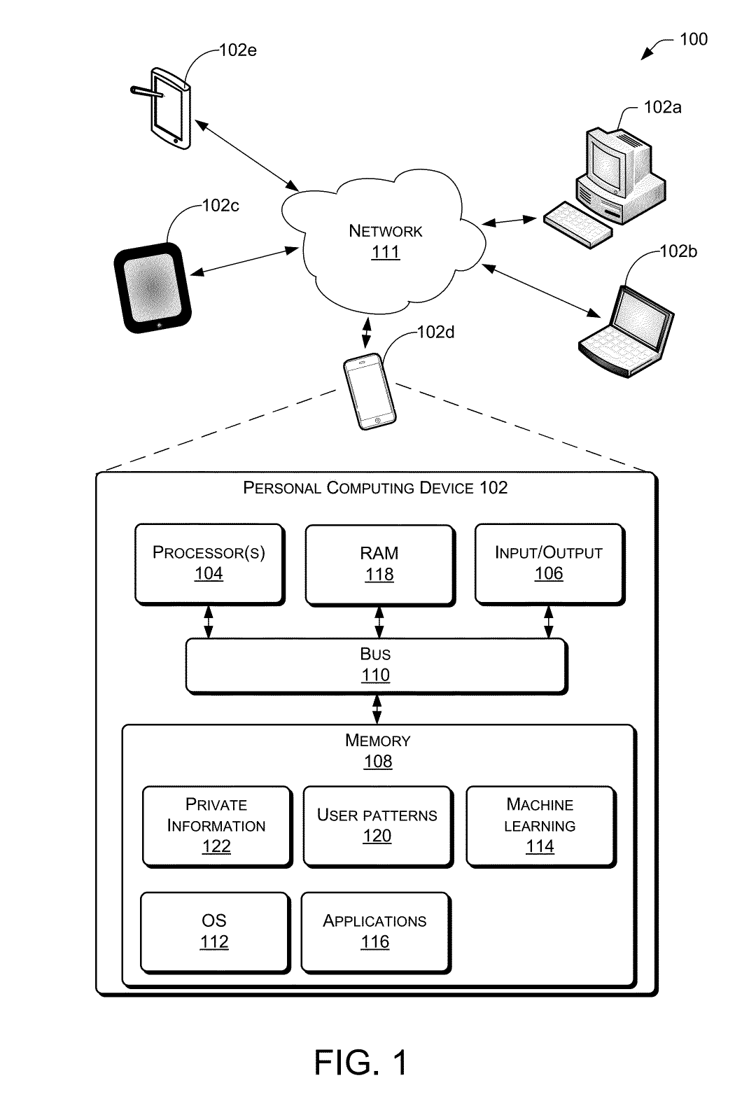

Various embodiments are described further with reference to FIGS. 1-11.

### Example Environment

The environment described below constitutes but one example and is not intended to limit the claims to any one particular operating environment. Other environments may be used without departing from the spirit and scope of the claimed subject matter. FIG. 1 shows an example environment 100 in which embodiments involving personalizing machine learning as described herein can operate. In some embodiments, the various devices and/or components of environment 100 include a variety of computing devices 102. In various embodiments, computing devices 102 may include devices 102a-102e. Although illustrated as a diverse variety of device types, computing devices 102 can be other device types and are not limited to the illustrated device types. Computing devices 102 can comprise any type of device with one or multiple processors 104 operably connected to an input/output interface 106 and memory 108, e.g., via a bus 110. Computing devices 102 can include personal computers such as, for example, desktop computers 102a, laptop computers 102b, tablet computers 102c, telecommunication devices 102d, personal digital assistants (PDAs) 102e, electronic book readers, wearable computers, automotive computers, gaming devices, etc. Computing devices 102 can also include business or retail oriented devices such as, for example, server computers, thin clients, terminals, and/or work stations. In some embodiments, computing devices 102 can include, for example, components for integration in a computing device, appliances, or another sort of device. In some embodiments, some or all of the functionality described as being performed by computing devices 102 may be implemented by one or more remote peer computing devices, a remote server or servers, or a cloud computing resource. For example, computing devices 102 can execute applications that are stored remotely from the computing devices.

In some embodiments, as shown regarding device 102d, memory 108 can store instructions executable by the processor(s) 104 including an operating system (OS) 112, a machine learning module 114, and programs or applications 116 that are loadable and executable by processor(s) 104. The one or more processors 104 may include one or more central processing units (CPUs), graphics processing units (GPUs), video buffer processors, and so on. In some implementations, machine learning module 114 comprises executable code stored in memory 108 and is executable by processor(s) 104 to collect information, locally by computing device 102, via input/output 106. The information is associated with applications 116. Machine learning module 114 selects a subset of a machine learning model stored in memory 108 (or, more particularly, stored in machine learning 114) to load into random access memory (RAM) 118. The selecting may be based, at least in part, on the information collected locally by personal computing device 102, and the subset of the machine learning model comprises less than all of the machine learning model. Machine learning module 114 may also access user patterns module 120 and private information module 122. For example, patterns module 120 may store user profiles that include history of actions by a user, applications executed over a period of time, and so on. Private information module 122 stores information collected or generated locally by personal computing device 102. Such private information may relate to the user or the user's actions. Such information can be accessed by machine learning module 114 to adjust a classification threshold value for the user, for example, to benefit the user of personal computing device 102. Private information is not shared or transmitted beyond personal computing device 102. Further, in some implementations, a user of personal computing device 102 has to “opt-in” or take other affirmative action to allow personal computing device 102 to store private information in private information module 122.

Though certain modules have been described as performing various operations, the modules are merely examples and the same or similar functionality may be performed by a greater or lesser number of modules. Moreover, the functions performed by the modules depicted need not necessarily be performed locally by a single device. Rather, some operations could be performed by a remote device (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some embodiments, computing device 102 can be associated with a camera capable of capturing images and/or video and/or a microphone capable of capturing audio. For example, input/output module 106 can incorporate such a camera and/or microphone. Memory 108 may include one or a combination of computer readable media.

Computer readable media may include computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media. In various embodiments, memory 108 is an example of computer storage media storing computer-executable instructions. When executed by processor(s) 104, the computer-executable instructions can configure the processor(s) to, among other things, execute an application and collect information associated with the application. The information may be collected locally by personal computing device 102. When executed, the computer-executable instructions can also configure the processor(s) to normalize a feature output of a machine learning model accessible by the application based, at least in part, on the information collected locally by the client device.

In various embodiments, an input device of input/output (I/O) interfaces 106 can be a direct-touch input device (e.g., a touch screen), an indirect-touch device (e.g., a touch pad), an indirect input device (e.g., a mouse, keyboard, a camera or camera array, etc.), or another type of non-tactile device, such as an audio input device.

Computing device(s) 102 may also include one or more input/output (I/O) interfaces 106 to allow the computing device 102 to communicate with other devices. Input/output (I/O) interfaces 106 can include one or more network interfaces to enable communications between computing device 102 and other networked devices such as other device(s) 102. Input/output (I/O) interfaces 106 can allow a device 102 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

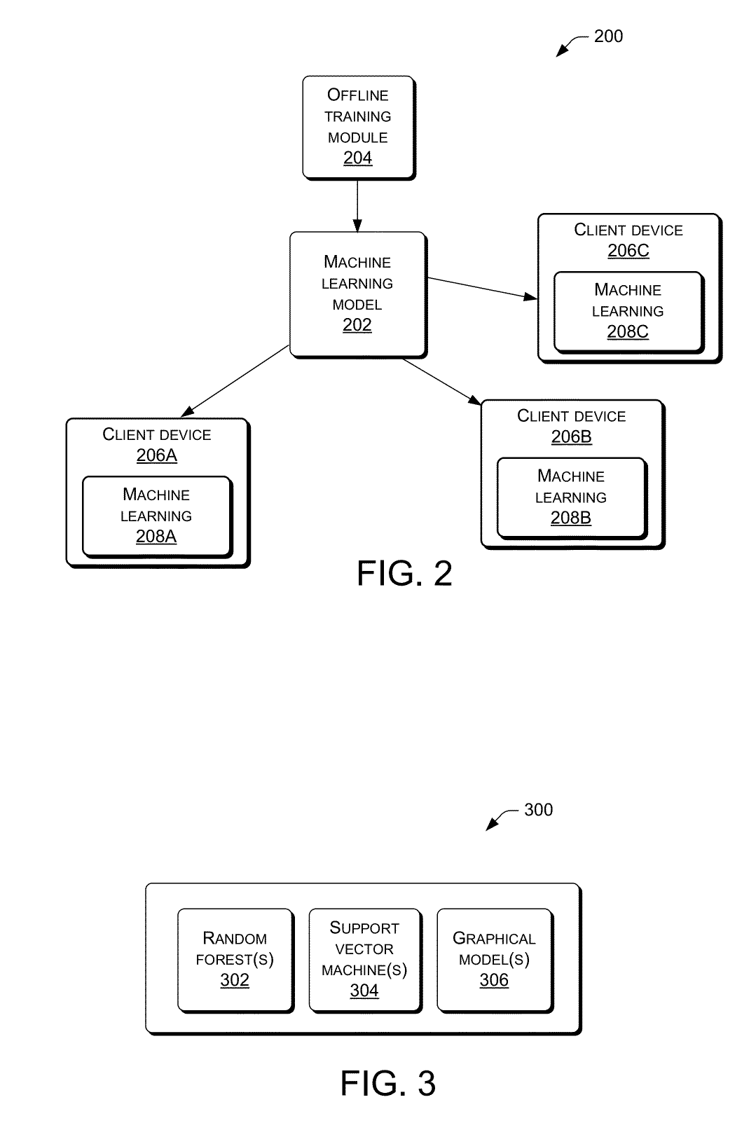

FIG. 2 is a block diagram of a machine learning system 200, according to various example embodiments. Machine learning system 200 includes machine learning model 202, offline training module 204, and a number of client devices 206A-C. Machine learning model 202 receives training data from offline training module 204. For example, training data can include data from a population, such as a population of users operating client devices or applications executed by a processor of client devices. Data can include information resulting from actions of users or can include information regarding the users themselves. For example, mouth sizes of each of a number of users can be measured while the users are engaged in a particular activity. Such measurements can be gleaned, for example, from images of the users captured at various or periodic times. Mouth size of a user can indicate a state of a user, such as the user's level of engagement with the particular activity, emotional state, or physical size, just to name a few examples. Data from the population can be used to train machine learning model 202. Subsequent to such training, machine learning model 202 can be implemented in client devices 206A-C. Thus, for example, training using the data from the population of users for offline training can act as initial conditions for the machine learning model.

Machine learning model 202, in part as a result of offline training module 204, can be configured for a relatively large population of users. For example, machine learning model 202 can include a number of classification threshold values that are set based on average characteristics of the population of users of offline training module 204. Client devices 206A-C can modify machine learning model 202, however, subsequent to machine learning model 202 being loaded onto client devices 206A-C. In this way, customized/personalized machine learning can occur on individual client devices 206A-C. The modified machine learning model is designated as machine learning 208A-C. In some implementations, for example, machine learning 208A comprises a portion of an operating system of client device 206A. Modifying machine learning on a client device is a form of local training of a machine learning model. Such training can utilize personal information already present on the client device, as explained below. Moreover, users of client devices can be confident that their personal information remains private while the client devices remain in their possession.

In some embodiments, characteristics of machine learning 208A-C change in accordance with particular users of client devices 206A-C. For example, machine learning 208A hosted by client device 206A and operated by a particular user can be different from machine learning 208B hosted by client device 206B and operated by another particular user. Behaviors and/or personal information of a user of a client device are considered for modifying various parameters of machine learning hosted by the client device. Behaviors of the user or personal information collected over a predetermined time can be considered. For example, machine learning 208A can be modified based, at least in part, on historical use patterns, behaviors, and/or personal information of a user of client device 206A over a period of time, such as hours, days, months, and so on. Accordingly, modification of machine learning 208A can continue with time, and become more personal to the particular user of client device 208A. A number of benefits result from machine learning 208A becoming more personal to the particular user. Among such benefits, precision of output of machine learning 208A increases, efficiency (e.g., speed) of operation of machine learning 208A increases, and memory footprint of machine learning 208A decreases, just to name a few example benefits. Additionally or alternatively, users may be allowed to opt out of the use of personal/private information to personalize the machine learning.

Client devices 206A-C can include personal computing devices that receive, store, and operate on data that a user of the personal computing device considers private. That is, the user intends to maintain such data within the personal computing device. Private data can include data files (e.g., text files, video files, image files, and audio files) comprising personal information regarding the user, behaviors of the user, attributes of the user, communications between the user and others, queries submitted by the user, and network sites visited by the user, just to name a few examples.

### Subset Selection of a Machine Learning Model

FIG. 3 is a block diagram of a machine learning model 300, according to various example embodiments. For example, machine learning model 300 may be the same as or similar to machine learning model 202 shown in FIG. 2. Machine learning model 300 includes functional blocks, such as random forest block 302, support vector machine block 304, and graphical models block 306. Random forest block 302 can include an ensemble learning method for classification that operates by constructing decision trees at training time. Random forest block 302 can output the class that is the mode of the classes output by individual trees, for example. Random forest block 302 can function as a framework including several interchangeable parts that can be mixed and matched to create a large number of particular models. Constructing a machine learning model in such a framework involves determining directions of decisions used in each node, determining types of predictors to use in each leaf, determining splitting objectives to optimize in each node, determining methods for injecting randomness into the trees, and so on.

Support vector machine block 304 classifies data for machine learning model 300. Support vector machine block 304 can function as a supervised learning model with associated learning algorithms that analyze data and recognize patterns, used for classification and regression analysis. For example, given a set of training data, each marked as belonging to one of two categories, a support vector machine training algorithm builds a machine learning model that assigns new training data into one category or the other.

Graphical models block 306 functions as a probabilistic model for which a graph denotes conditional dependence structures between random variables. Graphical models provide algorithms for discovering and analyzing structure in distributions and extract unstructured information. Applications of graphical models include information extraction, speech recognition, computer vision, and decoding of low-density parity-check codes, just to name a few examples.

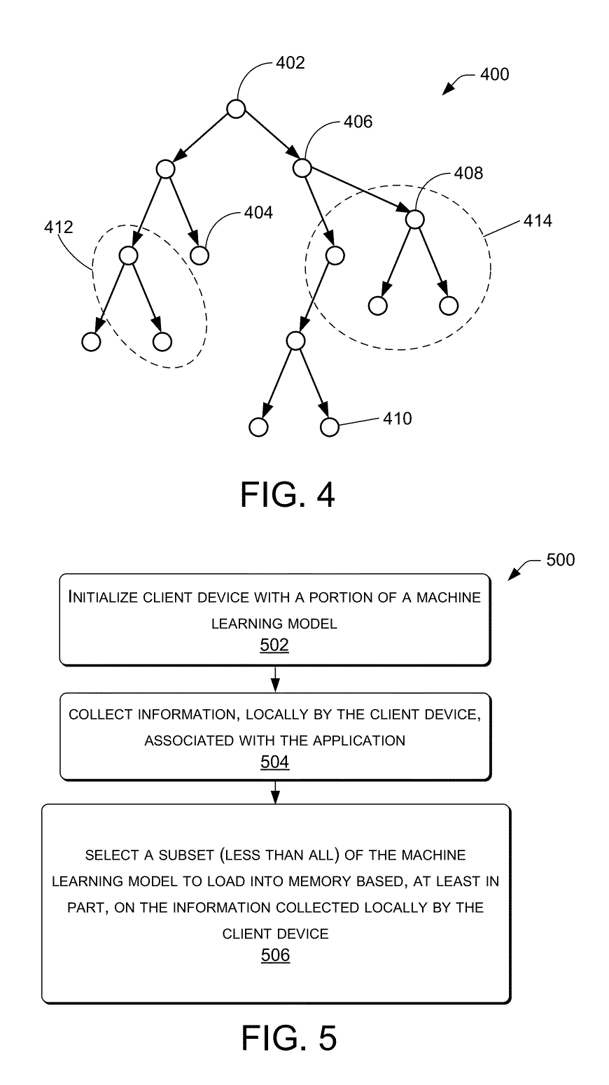

FIG. 4 shows a tree 400 of support vectors and nodes for a machine learning model hosted by a client device (e.g., client devices 206A-C), according to various example embodiments. For example, tree 400 includes decision nodes 402, 404, 406, 408, and 410 connected along particular paths by various support vectors (indicated by arrows). Tree 400 may represent merely a part of a larger tree including, for example, hundreds or thousands of nodes and support vectors.

A machine learning model operates by following support vectors and nodes of tree 400. Though a machine learning model corresponds to a large tree, of which tree 400 may be a relatively small part, generally only a portion of the tree is used at any one time. For example, portion 412 of tree 400 may not be used by a client device of a particular user. On the other hand, portion 414 of tree 400 may be used relatively often because of use patterns of the user. For example, if a machine learning model hosted by a client device includes a tree portion regarding voice commands and speech recognition, then that tree portion may rarely be used for a user of the client device who rarely utilizes voice commands and speech recognition on the client device. In such a case, in some embodiments, the rarely used tree portion need not be stored with the rest of the tree. For example, an entire machine learning model can be stored in read-only memory (ROM) while less than the entire machine learning model can be selectively stored in random access memory (RAM). In some implementations, rarely used tree portions may be archived or stored remotely in any of a number of types of memory or locations (e.g., a remote server or the cloud). Selectively storing only commonly-used portions of a machine learning model in RAM can provide a number of benefits, such as increasing speed of the machine learning model and reducing the amount of memory occupied by the machine learning model, compared to the case where the entire machine learning model is stored in RAM.

In some embodiments, portions of tree 400 can be loaded into RAM from ROM as a need for the portions arises. For example, if the user who rarely utilizes voice commands or speech recognition begins to do so, then the portion(s) of tree 400 pertaining to voice commands or speech recognition may subsequently be loaded from ROM to RAM. In some implementations, selectively loading portions of a machine learning model can be based, at least in part, on a likelihood or prediction that the portions will be used. Different users of client devices likely will operate their client devices differently. Accordingly, portions of a machine learning model will be stored differently for different users. In one example, the different users can operate a single client device at different times. In that case, as a consequence of a particular user logging on, or otherwise identifying themselves, to the client device, particular portions of a machine learning model hosted by the client device that are frequently used by the particular user may be loaded into RAM from ROM. Such particular portions can be different for different users. In another example, different users may each operate a different client device. In such a case, each client device can have different portions of a machine learning model loaded into RAM from ROM.

FIG. 5 is a flow diagram of a process 500 for selecting a subset of a machine learning model to load into RAM of a client device, according to various example embodiments. Performance can improve by loading merely portions of the machine learning model that will most likely be used by a particular user. At block 502, the client device is initialized by loading a portion of the machine learning model into RAM. At this initial stage, the portion of the machine learning model to be loaded into RAM can be selected based, at least in part, on type or content of applications hosted by the client device, history or patterns of use of the client device, type of client device, and so on. An entire machine learning model, of which the portion loaded into RAM is a part, can be hosted on the client device, in ROM, for example. In other cases, some parts of a machine learning model may be stored remotely and/or archived. In some implementations, the client device prioritizes various portions of the machine learning model to determine an order in which the various portions are loaded into RAM. Such prioritizing can be based, at least in part, on type or content of applications hosted by the client device, history or patterns of use of the client device, type of client device, and so on.

At block 504, information is collected locally by the client device. Such information is associated with an application, such as a search engine, gaming application, or speech recognition application, just to name a few examples. Such information can include text entered into the client device by the user, audio information, video information, captured images, and so on. In a particular example, the machine learning model can be associated with a voice recognition application. For instance, the machine learning model can be improved if, for example, collected information indicates whether the user writes technical documents or creative writing documents. In another example, the machine learning model can be associated with a Web browser for performing searches on the Internet. For instance, the machine learning model can be personalized if collected information indicates whether the user of the client device primarily searches the Web for shopping or for science research. For example, the Browser can auto-populate a search text box as a user types in a search word: a personalized machine learning model can provide the auto-populated words directed to the topic for which the user is most likely searching.

At block 506, a subset of a machine learning model is selected to load into memory, such as RAM. Such selecting is based, at least in part, on the information collected locally by the client device. The subset of the machine learning model comprises less than the entire machine learning model. For example, if the machine learning model is associated with a voice recognition application, then selection of a subset of the machine learning model to load into memory may depend, at least in part, on types of words or sounds used by a user of the client device, whether the user speaks with a particular accent, or whether the user writes technical documents or creative writing documents. In another example, if the machine learning model is associated with a web browser, then selection of a subset of the machine learning model to load into memory may depend, at least in part, on whether the user primarily searches the Internet for shopping or for scientific research.

A client device can use collected information to select portions of a machine learning model by statistically analyzing the information. For example, an application hosted by the client device can memorize the number of times particular nodes of a machine learning tree are visited, and develop a history or usage model. The machine learning model can allocate particular regions of memory (e.g., user patterns module 120, shown in FIG. 1) on the client device to store collected information, a history or usage model, or the number of times particular nodes are visited, for example.

In some implementations, the portion of the machine learning model other than the subset of the machine learning model may be loaded into RAM in response to the portion of the machine learning model being relevant to an input received during execution of the application. For example, if a user's actions or input initiates execution of a particular portion of an application, then a particular portion of a machine learning model may correspondingly be loaded into RAM. In a particular example, if a user, for the first time in a relatively long time, activates a part of an application associated with speech recognition, then a portion of a machine learning model associated with speech recognition may be loaded into RAM from ROM. In some implementations, the selected subset of the machine learning model can be greater than or less than the portion of the machine learning model selected at the initial stage, at block 502.

In addition to a number of other functions, a machine learning model may classify features into states. For example, mouth size of a user is a feature that can be classified as being in an open state or a closed state. Moreover, mouth size or state can be used as a parameter on which to determine whether the user is in a happy state or sad state, among a number of other emotional states. A machine learning model includes classifiers that make decisions based, at least in part, on comparing a value of a decision function ƒ(x) with a threshold value t. Increasing the threshold value t increases precision of the classification, though recall correspondingly decreases. For example, if a threshold value t for determining if a feature is in a particular state is set relatively high, then there will be relatively few determinations (e.g., recall) that the feature is in the particular state, but the fraction of the determinations being correct (e.g., precision) will be relatively high. On the other hand, decreasing the threshold value t decreases precision of the classification, though recall correspondingly increases.

### Classification Threshold Adjustment

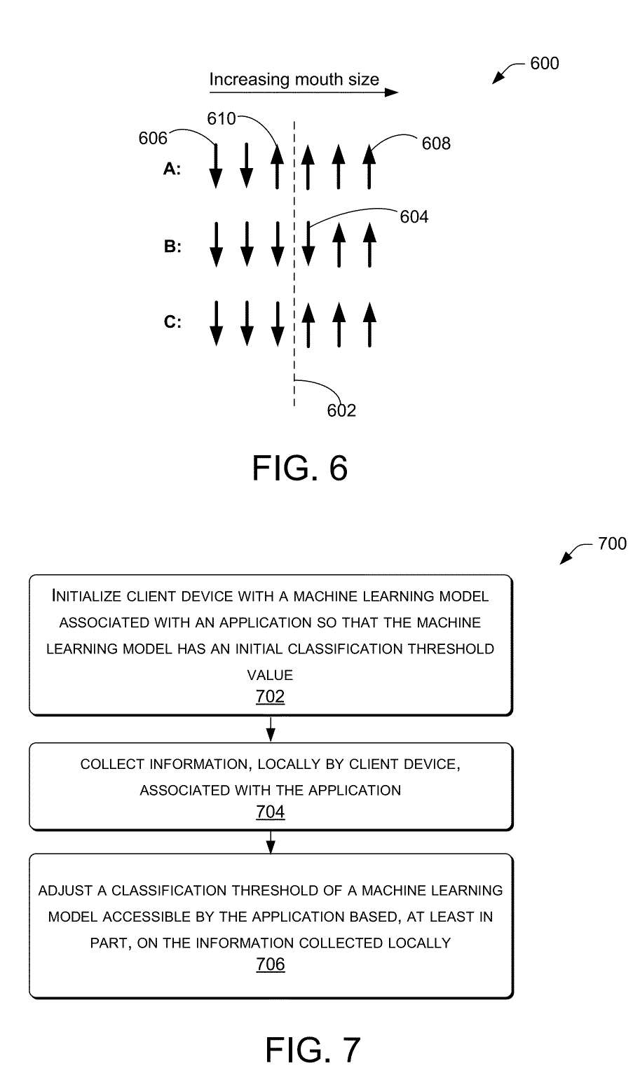

FIG. 6 is a schematic diagram of feature measurements 600 for three users A, B, and C with respect to a classification threshold value 602 of a machine learning model, according to various embodiments. In the example shown, feature measurements 600 illustrate a balance between precision and recall as determined, at least in part, by classification threshold value 602, which can be set differently for different users. As explained below, by adjusting a classification threshold value for a particular user, a machine learning model can more accurately predict measurement outcomes, as compared to the case of using a single classification threshold value for all users. A classification threshold value can initially be set during training, which is based on a plurality of users. Though such an initial value works well for a group of users, it may not work well for particular users.

In some implementations, a classification threshold value can be adjusted automatically (e.g., by the machine learning model being executed by the client device) for a particular user based, at least in part, on past and/or present behaviors of the particular user. In other implementations, a classification threshold value can be adjusted based, at least in part, on user input. In the latter implementations, for example, a user may desire to bias predictions by the machine learning model. In one example implementation, biasing can be performed explicitly by a user adjusting or inputting settings. In another example implementation, biasing can be performed implicitly based on user actions. Such biasing by the user can improve performance of the machine learning model.

Each arrow 604 represents a measurement or instance of a feature, such as a feature of a user or an action of the user. Each arrow is either in an up state or a down state. The arrows are placed from left to right based on measured mouth size of a user. For example, an arrow 606 toward the left end of the distribution represents small measured mouth size and an arrow 608 toward the right end of the distribution represents large measured mouth size. Measured mouth size (e.g., using a captured image) can be used to determine an emotional parameter of a user, e.g., whether the user is in a happy state or a not happy state. Arrow-down indicates mouth closed and arrow-up indicates mouth open in this example. Thus, in six measurements of mouth size, user A had their mouth closed two times and their mouth open four times. User B had their mouth closed four times and their mouth open two times. User C had their mouth closed three times and their mouth open three times.

As mentioned above, a machine learning model includes classifiers that make decisions based, at least in part, on comparing a value with a threshold value. In FIG. 6, mouths of users are classified as being closed if measurements of mouth size fall on the left of classification threshold value 602 and are classified as being open if measurements of mouth size fall on the right of classification threshold value 602. Thus, as can be seen in FIG. 6, if the machine learning model classifies users' mouths being open or closed based on classification threshold 602, then precision of results for the different users will vary. For example, measurement arrow 610 indicates an open mouth of user A, but arrow 610 falls to the left of classification threshold 602 so the machine learning model classifies the mouth of user A as being closed. In another example, measurement arrow 604 indicates a closed mouth of user B, but arrow 604 falls to the right of classification threshold 602 so the machine learning model classifies the mouth of user B as being open. For user C, measurement arrows indicate an open mouth for each measurement on the right of classification threshold 602 and a closed mouth for each measurement on the left of classification threshold 602. Thus, in this particular case, the machine learning model correctly classifies the mouth of user C in all cases.

As just demonstrated, a single threshold value applied to different users can yield different results. Classification threshold 602 is set correctly for user C, but is set too high for user A and too low for user B. If classification threshold 602 is adjusted to precisely work for user A, then it will become less precise for users B and C. Thus, there is no single classification threshold value that can be precise for all users. Moreover, increasing a threshold value increases precision of the classification, though recall correspondingly decreases. For example, if a threshold value t for determining if a feature is in a particular state is set relatively high, then there will be relatively few determinations (e.g., recall) that the feature is in the particular state, but the fraction of the determinations being correct (e.g., precision) will be relatively high. On the other hand, decreasing the threshold value t decreases precision of the classification, though recall correspondingly increases.

As explained above, a single classification threshold value applied to different users can yield different results. By applying a particular classification threshold value t to users having one type of use-profile or personal profile can provide relatively more accurate results than applying the same particular classification threshold value t to users having another type of use-profile or personal profile can provide less accurate results. Accordingly, in some embodiments, a classification threshold value t can be set based, at least in part, on a particular user's profile or a profile of a class of users having one or more common characteristics. Moreover, a classification threshold value t can be modified or adjusted based, at least in part, on behaviors of the particular users. For example, different classification threshold values can be assigned to different ethnic groups: Users having Asian descent, for example, statistically have physical features (e.g., eye size and body height) that are different from users having Caucasian descent. Therefore a different threshold value t may be appropriate for different ethnic groups.

A machine learning model can adjust a classification threshold value. To achieve uniform experience among multiple users, the following two conditions can be considered. First, feature distributions of a class value are approximately the same among any sub-population of users. This can be expressed as P′_{y=1}˜P_{y=1} for all ω′ being a subset of ω, where P represents probability and y is the target class predicted by the machine learning model. Second, classification threshold values are set so that precision and recall are at least approximately the same among the sub-populations of users. This can be expressed as

argmin_{t′}∥∫_{xεω′}P[[ƒ(x)>t′]]dx−∫_{xεω}P[[ƒ(x)>t]]dx∥. Equation 1

where t is the threshold, t′ is the personalized threshold, and x represents input signals such as, for example, image pixels or audio files. For example, a client device can accumulate a distribution ω′ over a span of time, and compute an adaptive classification threshold value according to equation 1. Moreover, if t′* is the optimal personal threshold, and t′ₙ is the estimation computed from equation 1 by drawing n samples, then t′ₙ→t′*, where n is the number of samples collected by the client device.

FIG. 7 is a flow diagram of a process 700 for adjusting a classification threshold of a machine learning model based, at least in part, on information collected locally by a client device, according to various example embodiments. At block 702, a machine learning model hosted by the client device includes an initial classification threshold value, which may be set to a value determined by a priori training of a generic machine learning model upon which the machine learning model hosted by the client device is based. For example, a classification threshold value of the generic machine learning model can be based, at least in part, on measured parameters of a population of users.

At block 704, information is collected, locally by the client device. Such information is associated with an application, such as a speech recognition application, a search engine, a game, or the like. At block 706, the machine learning model adjusts the classification threshold value based, at least in part, on the information collected locally by the client device. The machine learning model is accessible by the application, for example. In some implementations, the machine learning model adjusts the classification threshold value after a particular time, or after a particular amount of information is collected.

A particular example of process 700 can involve a smiling classifier to determine whether a user is smiling or not. This can be useful to determine whether the user is happy or sad, for example. To build a generic machine learning model, measurements of mouth sizes can be collected for a population of users (e.g., 100, 500, or 1000 or more people). Measurements can be taken from captured images of the users as the users play a video game, watch a television program, or the like. The measurements can indicate how often the users smile. Measurements can be performed for each user every 60 seconds for 3 hours, for example. These measurements can be used as an initial training set for the generic machine learning model, which will include an initial classification threshold value.

The initial classification threshold value will be used by a client device when the generic machine learning model is first loaded into the client device (e.g., see block 702 of process 700). Subsequent to this time, however, measurements will be made of a particular user of the client device. For example, measurements can be taken of mouth size of the user from captured images of the user as the user plays a video game, watches a television program, of the like. The measurements can indicate how often the user smiles. Measurements (e.g., collecting information, as in block 704 of process 700) can continue, and the classification threshold value can be adjusted accordingly, until the classification threshold value converges (e.g., becomes substantially constant). For example, checking consecutive threshold computations in the latest time frames allows for a determination of whether the average change between consecutive threshold values is below a particular predetermined small number (e.g., 0.00001). Thus, for example, the generic machine learning model may expect the user to be smiling 40% of the time. The user, however, may be observed to smile 25% of the time, as determined by collecting information about the user (e.g., measuring mouth size from captured images). Accordingly, the classification threshold value can be adjusted (e.g., see block 706 of process 700) to account for the smiling rate observed for the user. The machine learning model may be personalized in this way, for example.

### Normalization

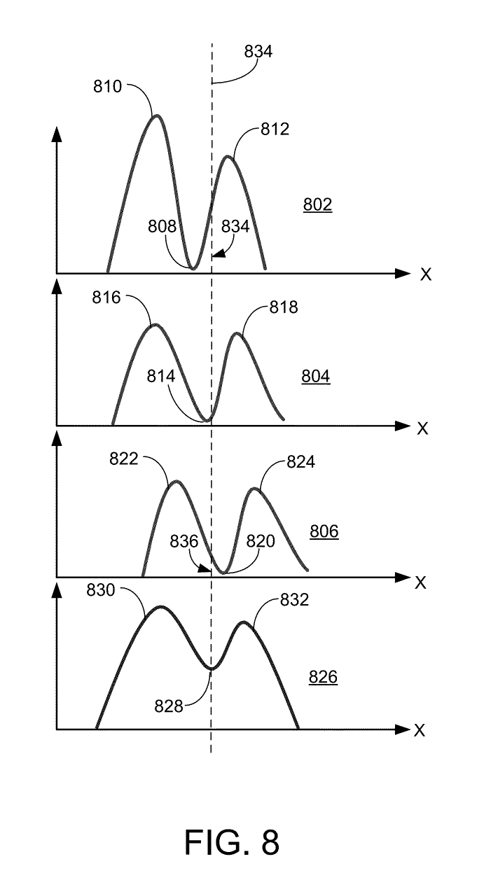

FIG. 8 shows three example distributions of a feature of three different users of a client device, and an aggregated distribution of the three example distributions, according to various example embodiments. Aggregating multiple feature distributions is a technique for de-identifying or “anonymizing” feature distributions of individual users, which can be considered personal data. Aggregating multiple feature distributions is also a technique for combining sampling data from multiple users.

Feature distribution 802 represents a distribution of measurements of a particular parameter of a first user of a client device, feature distribution 804 represents a distribution of measurements of the particular parameter of a second user of a client device, and feature distribution 806 represents a distribution of measurements of the particular parameter of a third user of a client device. In some implementations the client device can be the same for two or more of the users. For example, two or more users may share a single client device. In other implementations, however, client devices are different for each user.

Parameters of users are measured a number of times to generate feature distributions 802-806. Such parameters can include a physical feature of a particular user, such as mouth size, eye size, voice volume, and so on. Measurements of parameters can be gleaned from information collected by a client device operated by the user. Collecting such information can include capturing an image of the user, capturing a voice sample of the user, receiving a search query from the user, and so on.

As an example, consider that the parameters of feature distributions 802-806 are mouth sizes of the three users. Measurements of mouth sizes can indicate whether a user is talking, smiling, laughing, or speaking, for example. The X-axes of feature distributions 802-806 represent increasing mouth size. Information from images of each user captured periodically or from time to time by the client device of the users can be used to measure mouth sizes. Thus, for example, feature distribution 802 represents a distribution of mouth size measurements for the first user, feature distribution 804 represents a distribution of mouth size measurements for the second user, and feature distribution 806 represents a distribution of mouth size measurements for the third user. As can be expected, a particular physical feature of one user is generally different from the particular physical feature of another user. Maxima and minima (e.g., peaks and valleys) of a feature distribution (e.g., distribution of mouth sizes) can be used to indicate a number of things, such as various states of the feature of a user. For example, a local minimum 808 between two local maxima 810 and 812 in feature distribution 802 of the first user's mouth size can be used to define a classification boundary between the user's mouth being open or the user's mouth being closed. Thus, mouth size measurements to the left of local minimum 808 indicate the user's mouth being closed at the time of sampling (e.g., at the time of image capture). Conversely, mouth size measurements to the right of local minimum 808 indicate the user's mouth being open at the time of sampling.

For the second user, a local minimum 814 between two local maxima 816 and 818 in feature distribution 804 of the second user's mouth size can be used to define a classification boundary between the user's mouth being open or the user's mouth being closed. Similarly, for the third user, a local minimum 820 between two local maxima 822 and 824 in feature distribution 806 of the third user's mouth size can be used to define a classification boundary between the user's mouth being open or the user's mouth being closed. In general, feature distributions of values for different users will be different. In particular, positions and magnitudes of peaks and valleys, and thus positions of classification boundaries, of the feature distributions are different for different users. Accordingly, and undesirably, aggregating feature distributions of a number of users leads to loss of resolution (e.g., blurring) of the feature distributions and concomitant loss of information regarding feature distributions of the individual users. For example, aggregated feature distribution 826 is a sum or superposition of feature distributions 802-806. A local minimum 828 between two local maxima 830 and 832 in aggregated feature distribution 826 can be used to define a classification boundary 834 between all of the users' mouths being open or the users' mouths being closed. Unfortunately, classification boundary 834 is defined with less certainty as compared to the cases for classification boundaries for the individual feature distributions 802-806. For example, certainty or confidence level of a classification boundary can be quantified in terms of relative magnitudes of the local minimum and the adjacent local maxima: The magnitude of local minimum 828 is relatively large compared to the magnitudes of local maxima 830 and 832 in aggregated feature distribution 826.

Accordingly, classification boundary 834 of the aggregated feature distribution can be relatively inaccurate in terms of the individual feature distributions 802-806. For example, the classification boundary corresponding to local minimum 808 of feature distribution 802 is offset from classification boundary 834 of the aggregated feature distribution, as indicated by arrow 834. As another example, the classification boundary corresponding to local minimum 836 of feature distribution 806 is offset from classification boundary 834 of the aggregated feature distribution, as indicated by arrow 836. Thus, using classification boundary 834 of the aggregated feature distribution for individual users can lead to errors or misclassifications. A process of normalization can alleviate such problems that arise from aggregating feature distributions of multiple users, as described below.

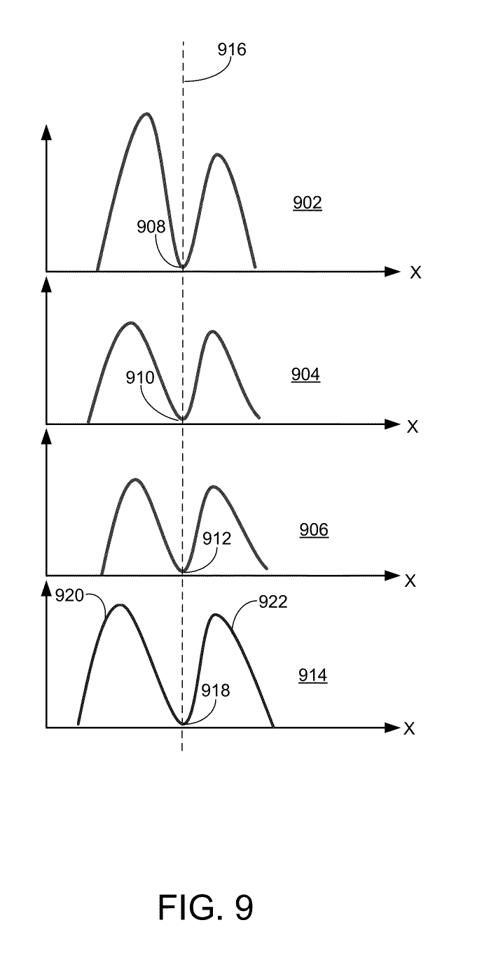

FIG. 9 shows normalized example distributions of a feature of three different users of a client device, and an aggregated distribution of the three normalized example feature distributions, according to various example embodiments. Such normalized feature distributions can be generated by applying a normalization process to the feature distributions. For example, normalized feature distribution 902 results from normalizing feature distribution 802, shown in FIG. 8. Similarly, normalized feature distribution 904 results from normalizing feature distribution 804, and normalized feature distribution 906 results from normalizing feature distribution 806.

In one implementation, a normalization process applied to a feature distribution sets a local minimum to a particular predefined value. Extending this approach, applying such a normalization process to multiple feature distributions sets local minima to a particular predefined value. Thus, in the example feature distributions shown in FIG. 9, minima 908, 910, 912 of each of normalized feature distributions 902-906 are aligned with one another along the X-axes. In such a case, an aggregated distribution 914 of normalized feature distributions 902-906 also includes a local minimum 916 that aligns with minima 908-912 of normalized feature distributions 902-906. Because of such an alignment of local minima, classification boundaries of the normalized feature distributions 902-906 are the same as a classification boundary 916, defined by the X-position of local minimum 918, of aggregated feature distribution 914.

As mentioned above, feature distributions of values are generally different for different users. In particular, positions and magnitudes of peaks and valleys, and thus positions of classification boundaries, of the feature distributions are different for different users. In such a case, aggregating feature distributions of a number of users undesirably leads to loss of resolution (e.g., blurring) of the feature distributions and concomitant loss of information regarding feature distributions of the individual users. A normalization process applied to the individual feature distributions, however, can lead to an aggregated feature distribution that maintains a classification boundary defined with greater certainty as compared to the case without a normalization process (e.g., aggregated feature distribution 826). For example, as mentioned above, certainty or confidence level of a classification boundary can be quantified in terms of relative magnitudes of the local minimum and the adjacent local maxima. The magnitude of local minimum 918 is relatively small compared to the magnitudes of local maxima 920 and 922 of aggregated feature distribution 914. Thus, aggregated feature distribution 914, based on normalized feature distributions 902-906, has a more distinct (e.g., deeper) local minimum than does aggregated feature distribution 826 (FIG. 8), which is based on un-normalized feature distributions 802-806. In other words, aggregated feature distribution 914, based on normalized feature distributions 902-906, provides a clear decision boundary (classification boundary) for determining a state of a feature of a user (e.g., user's mouth open or closed).

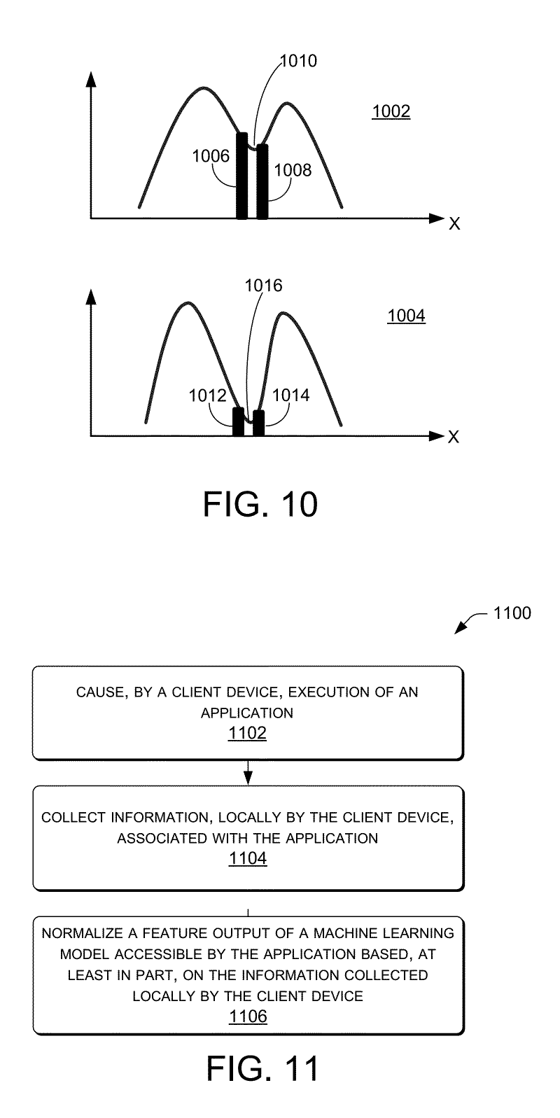

FIG. 10 shows misclassification errors with respect to aggregated distributions of a feature, according to various example embodiments. In particular, aggregated feature distribution 1002 is based on un-normalized feature distributions (e.g., feature distributions 802-806) while aggregated feature distribution 1004 is based on normalized feature distributions (e.g., feature distributions 902-906). Resolution is reduced in a process of aggregating un-normalized feature distributions. Thus, misclassification errors 1006 and 1008 can occur within a “blurring zone” near the local minimum 1010 of aggregated feature distribution 1002. Such a blurring zone results from loss of resolution, and concomitant increase in uncertainty, of a classification boundary defined by local minimum 1010.

In contrast, resolution is maintained in a process of aggregating normalized feature distributions. Thus, misclassification errors 1012 and 1014 occur within a relatively small “blurring zone” near the local minimum 1016 of aggregated feature distribution 1004. Errors 1012 and 1014 are relatively small, and a classification boundary defined by local minimum 1016 is relatively precise.

In some embodiments, a normalization process can be expressed as x′=g(x;P′), where P′ is a feature distribution of a single user of a client device of a feature x, and g is a normalization function. P′ can be estimated by observing samples on the client device, for example. Referring to errors shown in FIG. 10, a difference between errors 1006, 1008 and errors 1012, 1014 is equal to Δg,f. Moreover, P represents the blurred distribution of an aggregated feature distribution, and P_{g} represents an example normalized feature distribution (g is the normalization function). Accordingly, given any classifier f(x) and assuming the error reduction is Δg,f=E_{P}[ε_{f}]−E_{Pg}[εd], error reduction can be performed by applying real-time normalization with n samples, Δgₙ,f will converge to Δg,f in probability: Δgₙ,f→Δg,f. This equation shows that normalization can reduce the error by Δg,f ideally. By online normalization on a client device, such error reduction can be achieved after a finite number of samples (e.g., over a certain amount of time).

FIG. 11 is a flow diagram of a process 1100 for normalizing a feature output of a machine learning model based, at least in part, on information collected locally by a client device, according to various example embodiments. At block 1102, a client device executes an application. At block 1104, the client device collects information associated with the application. The information is collected locally by the client device. In other embodiments, however, a feature output of a machine learning model can be updated, or further refined, by using de-identified data from a network. At block 1106, a feature output of a machine learning model accessible by the application is normalized based, at least in part, on the information collected locally by the client device. In some embodiments, normalizing the feature output of a machine learning model generates a normalized output that can be aggregated with de-identified data received from a source external to the client device.

In some embodiments, methods described above are performed by a server in a network (e.g., the Internet or the cloud). The server performs normalization and aligns feature distributions of data collected by multiple client devices. The server, for example, receives, from a first client device, a first feature distribution generated by a first machine learning model hosted by the first client device, and receives, from a second client device, a second feature distribution generated by a second machine learning model hosted by the second client device. The server subsequently normalizes the first feature distribution with respect to the second feature distribution so that classification boundaries for each of the first feature distribution and the second feature distribution align with one another. The server then provides to the first client device a normalized first feature distribution resulting from normalizing the first feature distribution with respect to the second feature distribution. The first feature distribution is based, at least in part, on information collected locally by the first client device. The method can further comprise normalizing the first feature distribution with respect to a training distribution so that the classification boundaries for each of the first feature distribution and the training distribution align with one another.

The flows of operations illustrated in FIGS. 5, 7, and 11 are illustrated as collections of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor(s) to perform the recited operations. In the context of hardware, the blocks may represent one or more circuits (e.g., FPGAs, application specific integrated circuits—ASICs, etc.) configured to execute the recited operations.

Any routine descriptions, elements, or blocks in the flows of operations illustrated in FIGS. 5, 7, and 11 may represent modules, segments, or portions of code that include one or more executable instructions for implementing specific logical functions or elements in the routine.

### CONCLUSION

Although the techniques have been described in language specific to structural features and/or methodological acts, it is to be understood that the appended claims are not necessarily limited to the features or acts described. Rather, the features and acts are described as example implementations of such techniques.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “might” or “may,” unless specifically stated otherwise, are used to indicate that certain embodiments include, while other embodiments do not include, the noted features, elements and/or steps. Thus, unless otherwise stated, such conditional language is not intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y or Z,” unless specifically stated otherwise, is to be understood to present that an item, term, etc. may be either X, or Y, or Z, or a combination thereof.

Many variations and modifications may be made to the above-described embodiments, the elements of which are to be understood as being among other acceptable examples. All such modifications and variations are intended to be included herein within the scope of this disclosure.

What is claimed is:

1. A method comprising:
causing, by a client device, execution of an application;
collecting information, locally by the client device, associated with the application; and
normalizing a feature output of a machine learning model accessible by the application based, at least in part, on the information collected locally by the client device.

2. The method of claim 1, wherein normalizing the feature output of the machine learning model further comprises:
aligning a classification boundary of the feature output with a classification boundary of another feature output of a machine learning model in another client device.

3. The method of claim 1, wherein normalizing the feature output of the machine learning model generates a normalized output, and further comprises:
receiving de-identified data from external to the client device; and
aggregating the normalized output with the de-identified data.

4. The method of claim 1, wherein the feature output of the machine learning model is responsive to a pattern of behavior of a user of the client device over at least a predetermined time.

5. The method of claim 1, wherein collecting information comprises one or more of the following: capturing an image of a user of the client device, capturing a voice sample of the user of the client device, or receiving a search query from the user of the client device.

6. The method of claim 1, further comprising:
adjusting a classification threshold of the machine learning model based, at least in part, on the information collected locally by the client device.

7. The method of claim 1, further comprising:
selecting a subset of the machine learning model to load into memory, wherein the selecting is based, at least in part, on the information collected locally by the client device, and wherein the subset of the machine learning model comprises less than all of the machine learning model.

8. A system comprising:
one or more processors; and
memory storing instructions that, when executed by the one or more processors, configure the one or more processors to perform operations comprising:
executing an application;
collecting information, locally by the system, associated with the application; and
adjusting a classification threshold of a machine learning model accessible by the application based, at least in part, on the information collected locally by the system.

9. The system of claim 8, the operations further comprising:
normalizing a feature output of the machine learning model based, at least in part, on the information collected locally by the system.

10. The system of claim 9, wherein the feature output of the machine learning model is responsive to a pattern of behavior of a user of the system over at least a predetermined time.

11. The system of claim 8, wherein collecting information comprises one or more of the following: capturing an image of a user of the system, capturing a voice sample of the user of the system, or receiving a search query from the user of the system.

12. The system of claim 8, wherein the information comprises private information of a user of the system.

13. The system of claim 8, the operations further comprising:
selecting a subset of the machine learning model to load into memory, wherein the selecting is based, at least in part, on the information collected locally by the system, and wherein the subset of the machine learning model comprises less than all of the machine learning model.

14. Computer-readable storage media of a client device storing computer-executable instructions that, when executed by one or more processors of the client device, configure the one or more processors to perform operations comprising:
executing an application;
collecting information, locally by the client device, associated with the application; and
selecting a subset of the machine learning model to load into memory, wherein the selecting is based, at least in part, on the information collected locally by the client device, and wherein the subset of the machine learning model comprises less than all of the machine learning model.

15. The computer-readable storage medium of claim 14, wherein loading the subset of the machine learning model further comprises loading the subset of the machine learning model into random access memory (RAM), and further comprising loading a portion of the machine learning model other than the subset of the machine learning model into the RAM in response to the portion of the machine learning model being relevant to an input received during execution of the application.

16. The computer-readable storage medium of claim 15, the operations further comprising:
prioritizing various portions of the machine learning model to determine an order in which the various portions of the machine learning model are to be loaded into the RAM, wherein the prioritizing is based, at least in part, on type of the application, or history or patterns of use of the client device.

17. The computer-readable storage medium of claim 14, the operations further comprising:
normalizing a feature output of the machine learning model based, at least in part, on the information collected locally by the client device.

18. The computer-readable storage medium of claim 17, wherein the feature output of the machine learning model is responsive to a pattern of behavior of a user of the system over at least a predetermined time.

19. The computer-readable storage medium of claim 14, wherein collecting information, locally by the client device, comprises monitoring one or more use patterns of a user of the client device.

20. The computer-readable storage medium of claim 14, the operations further comprising:
adjusting a classification threshold of the machine learning model based, at least in part, on the information collected locally by the client device.
